(19) United States
(12) Patent Application Publication
(10) Pub. No.: US 2006/0084360 A1
(43) Pub. Date: Apr. 20, 2006

(54) Smell and tell toy

(76) Inventor: Max M. Stern, Lake Forest, CA (US)

Correspondence Address: MAX M. STERN, 24284 ONTARIO LANE, LAKE FOREST, CA, 92630, US

(21) Appl. No.: 10/964,522

(22) Filed: Oct. 14, 2004

(51) Int. Cl. A63H 5/00

(52) U.S. Cl. 446/397

(57) ABSTRACT

This device is a means to play back an audio recording, that is activated when movement occurs and to therefore increase this appeal, be it for a human or animal as the end user, incorporates a recognizable smell, material, size and appearance, to encourage that specific end user to actually make contact with the device, for the purpose of play, to teach, to possibly encourage feeding, calm, or collect.

### BACKGROUND OF THIS INVENTION

This Invention relates to toys, which as a play item have been around for years, such as a simple piece of wood that was thrown around, or a whole fruit that was kicked or even thrown.

They have been used to assist in teaching, calming, satisfying, collecting, fun or even for display purposes. Having made this statement it becomes obvious that a toy can serve many functions or purposes.

In the world of today some are even equipped with audio capabilities that can replay prerecorded or recorded messages or music.

This Invention can replay an input message and to attract the end user to this device, not only by the visual appearance, a smell has been incorporated, that appeals to that specific end user, whereby it entices that intended user to play with the toy.

This device, to have even more appeal for its intended end user, has been produced with materials or fabrics that appeal to that individual end users preferences or familiarity.

The shape, size, smell, or material utilized in its composition are going to be based on the application that it is intended to be utilized for, such as a child, older person, dog, cat bird, etc.

The invention of Dankman, U.S. Pat. No. 54,221,927 filed on Aug. 8 1978, is a toy that responds to human speech. My invention replays the input audio when it is moved.

The invention of William U.S. Pat. No. 5,184,971 filed on Mar. 8, 1991, is a toy produced in the shape of a push button telephone, so that on pushing any button for activation, playing back of the input message of that button only will occur. My invention has no buttons for activation, to replay the input audio.

The invention of Lacombe U.S. Pat. No. 5,279,514 filed on Nov. 16, 1992, is a toy that has audio output capabilities. The activation in this case requires that a switch in the paw has to be compressed, to complete the circuit for a replay of the audio. My invention to replay the input message requires only that the toy be moved.

The invention of Basile U.S. Pat. No. 5,468,172 filed on May 8, 1994, is a toy doll, with audio capabilities, that requires a switch to be pushed for activation. My invention on being moved causes the audio to play back.

The invention of Leyser U.S. Pat. No. 5,489,231 filed on Sep. 2, 1994 is a stuffed toy with audio output capabilities, as well as using different fabrics that can be removed or attached only to specific locations, so that the user can be taught to place them back in the original position. My invention does not have any components that are intended to be removed.

The invention of Masuda U.S. Pat. No. D407,766 filed on Nov. 5, 1997 is a toy that can output audio sound, that can be used as a purse or container and comes with a strap. My invention does not double as a purse or container so that items can be carried around.

The invention of Gabai U.S. Pat. No. 6,206,745 filed on Apr. 17, 1998, is a toy which can be controlled by using a computer, not only to assemble but to also alter the appearance of the toy, that has the ability to output audio. My invention has no external computer and requires only movement of the toy to play audio.

The invention of Casola U.S. Pat. No. 6,196,893 filed on Sep. 11 1998, has audio playback capabilities, whereby a switch has to physically be activated. My invention when moved will play back the input audio.

The invention of Smirnov U.S. Pat. No. 6,585,556 filed on May 11, 2001, is a talking toy, requiring external activation of the sensor to play the audio. My invention requires only slight movement of the toy to produce the audio output.

The invention of Dubois Et Al U.S. Pat. No. 6,547,629 filed on May 15, 2001, is an audio toy that requires the actuator mechanism to be activated for either the sound, or speech, or both actuators to be activated to produce both speech and sound at the same time. My invention requires only movement to replay the audio.

The invention of Chan U.S. Pat. No. 6,609,943 filed on Feb. 5, 2002, is an electronic toy that requires an external switch means to activate for sound to be emitted. My invention requires only slight movement to play back the input audio.

Non of these devices mentioned have incorporated the sensation of having smell included, either artificially or by attaching or inserting a particular smell, that appeals and will therefore attract the intended end user to play with this toy. To increase even more the appeal the toy in its construction could have a part or all of the housing produced of a material or fabric that is familiar to the end user, which in some cases might even include clothing that is used to complete the outside.

This last statement will become even more clear and apparent after a few examples of how this new device is going to be produced for the intended end user.

### SUMMARY OF THIS INVENTION

This invention is a means with an assortment of shapes, sizes, fabrics and smells, to produce a device that will be targeted for specific end users. The device will allow a dog to have its own device, while a cat or child will have a completely different device in appearance, size, fabrication and shape.

Each toy device would contain a changeable audio recording that will be input by a human. Seeing that many end users are going to want to play with the device, which are very different in many aspects, I am going to set out two examples that will illustrate this statement; they are namely a dog and bird.

1. A pet dog left at home all day or brought to a dog kennel overnight may hear a prerecorded familiar calming voice (activated by movement of the device), smell of beef or a treat, impregnated into the material that feels like a bone.

2. A bird in a cage regularly approaches a receptacle that contains bird seed. In this case an artificial looking hanging tree like limb that also contains the bird's food has been configured, so that movement of the limb will take place. The limbs fabric has been produced to look like bark and been impregnated with the smell of bird seed. The bird will be attracted to the limb, by the food and the smell, upon touching the limb, movement will occur causing the audio output to play. This device would assist enormously should one be trying to teach a bird to talk, or for company for the bird.

This device in its application does combine prerecorded output sounds that can be changed, with a familiar feel of texture, size and shape that includes a smell appealing to that individual end users taste. It can serve as a toy, a pacifier, or a source of comfort from toddlers to adults, household pets, or other animals, the sick or aged.

Shape, size, smell and texture are going to be based on the application that it is intended to be used for, such as, a dog it would have the smell of a treat or beef and the texture of a bone. When used for a cat, it could be in the shape of a fish, with the external texture being soft to the touch impregnated with the smell of fish. In the case of a bird, a look alike tree with bark texture would be an appropriate external covering with the smell of bird seed impregnated into the fabric.

None of these devices are intended to be eaten.

These and other features of the invention will become more apparent upon review of the various adaptations and associated drawings that are appended hereto. It is from these materials as a whole that the scope of protection sought by the inventor may be gleamed.

### BRIEF DESCRIPTION OF THE DRAWINGS

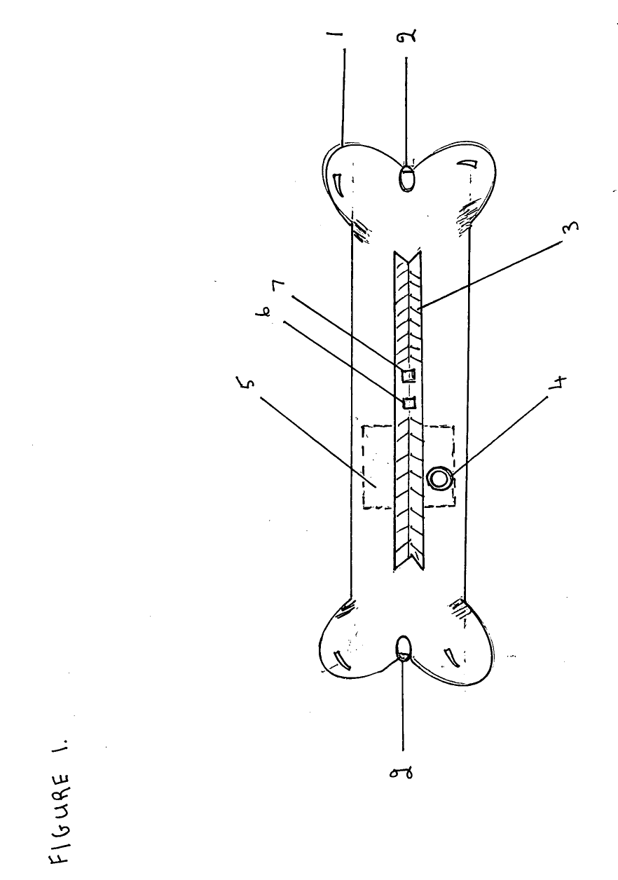

Drawing FIG. 1, is a cut away view showing the placement of all of the electronic components, with audio capabilities in and on, a look alike bone.

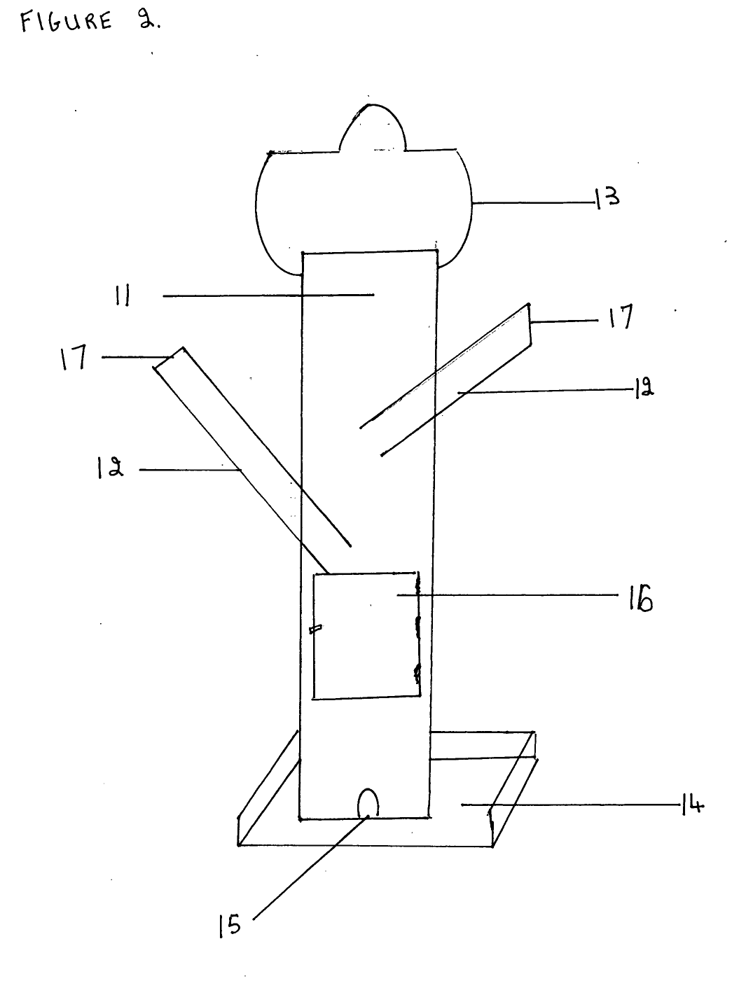

Drawings FIG. 2, is a front view of a look alike tree limb, which functions as a bird feeder, with electronic components, that also includes audio capabilities, located behind a closed door.

### NUMERALS OF THE EMBODIMENTS

1) Bone
2) Speakers
3) Recessed groove
4) Battery
5) Electronics that includes chip, with record and play back ability and movement detection equipment
6) Clear old message switch
7) Record function
11) Tree Limb
12) Branch
13) Wire loop
14) Ledge
15) Opening
16) Door
17) Speakers

### DETAILED DESCRIPTION OF THE DRAWINGS

FIG. 1, is a look alike dogs bone (1) that has been manufactured with materials that have the texture of a real bone. The bone (1) has been impregnated with the smell of a dog's treat or meat, to encourage the animal to play with this device.

The inside of the bone (1) has been fitted with all of the electronics, which includes the chip, with record and playback ability and movement detection equipment (5) and the battery (4).

The replay of the recorded message occurs when movement of the bone (1) is created. No outside switch is touched for activation.

The bone (1) has a recessed groove (3) on one side allowing for two switches, namely to clear the old message (6) or to record a new message (7) on the audio component. The groove (3) serves a very important purpose, so that the end user in this case a dog, should not be able to manipulate the switches (6) and (7) that have therefore been set inside this depression, to eliminate accidental activation by the user.

To hear the recorded message, the bone (1) is equipped with a speaker (2) at each end and this occurs when movement of the bone (1) is detected by the electronics, whereby the prerecorded message is then emitted from the speakers (2).

FIG. 2, has been configured in the shape of a tree limb (11), with two branches (12). The same electronic components have been imbedded inside this tree limb (11) as exist in FIG. 1, to perform the same tasks. The texture of the tree limb (11) looks and feels like bark, that has been impregnated with the smell of bird seed.

This tree limb (11) is intended to be suspended in a bird's cage by the wire loop(13) serving as a bird feeder, while at the same time incorporating other necessary features to make this device perform correctly.

The tree limb (11) has the electronics concealed behind a hinged door (16), for the intended purpose, that no bird should be able to manipulate any of the components. The door (16) also gives access to fill up the bird feeder, as the bird eats from the opening (15), while standing on the ledge (14) that surrounds the feeder.

The bird on pecking for seed, landing on the ledge (14) or sitting on a branch (12) will cause movement of the bird feeder. This will result in the prerecorded message to be played back from the two speakers (17) at the end of each branch (12).

This device will assist greatly in teaching a bird that has talking ability to repeat the audio output, it can also have a calming effect.

Shape, size, smell, appearance and material have all been combined to make the device appealing, whereby the end user will want to come into contact, thereby causing the recorded message to be played back. This device will still want to be touched even if the audio is not operating.

Accordingly, the main objectives of this invention are for many and varied end users to play with this device, for it to have a calming effect, to teach, to possibly feed or just for display purposes.

It is from these combinations and components as a whole that the scope of protection by the inventor may be gleamed.

What is claimed is:

1) A toy that is composed of special features intended for a specific end user.

2) The device of claim (1) to attract that intended end user be they human, animal, young or old is comprised of;
A) a material that is familiar in touch.
B) a material that has been artificially impregnated with an appropriate attractive smell.
C) a visually appealing appearance.

3) The device of claim (1) incorporates internal recording and playback audio electronic components.

4) The device of claim (3) plays the recorded audio, when movement is detected that triggers the activation for the replay.

5) The device of claim (2) therefore having encouraged the intended user to make contact with this device,
A) will have a calming effect.
B) to just play with this device.
C) or teach that intended end user, with the prerecorded playback audio.
